(19) United States
(12) Patent Application Publication
(10) Pub. No.: US 2017/0248752 A1
(43) Pub. Date: Aug. 31, 2017

(54) Portable Linear Worklight

(71) Applicant: Gelica Optical Systems Corporation, New Taipei City (TW)

(72) Inventors: Walter Dow WU, New Taipei City (TW); Chih Ming YEN, New Taipei City (TW); Shih Che CHEN, New Taipei City (TW)

(21) Appl. No.: 15/054,099

(22) Filed: Feb. 25, 2016

(51) Int. Cl. F21V 8/00; F21V 7/00; F21V 17/12; F21V 3/00; F21V 13/04; F21V 15/01; F21L 4/00; F21V 5/04

(52) U.S. Cl. CPC G02B 6/0096; F21L 4/005; F21V 7/00; F21V 5/04; F21V 3/00; F21V 13/04; F21V 15/01; F21V 17/12; F21Y 2115/10

(57) ABSTRACT

A portable linear worklight for converting point light into a linear light source is disclosed. The portable linear worklight comprises a worklight body and a lens. A transparent light pipe is positioned between an upper reflector and a lower reflector inside the worklight body. The lower reflector holds the light pipe and reflects light back into the light pipe. A light emitting diode in a battery housing emits light into a light receiving end of the light pipe. The received light travels trough the light pipe and is emitted from a light emitting surface of the light pipe. The upper reflector reflects some of the light emitted from the light emitting surface and directs the light toward the lens and the light exits the worklight body.

### BACKGROUND OF THE INVENTION

Field of the Invention

The present invention relates to lighting devices. More specifically, the present invention discloses a portable worklight device that is applied to a flashlight battery housing to convert a light emitting diode point light into a linear light source.

Description of the Prior Art

The conventional flashlight emits a point light in the direction where the flashlight is aimed.

While useful for such situations as lighting a pathway while walking, the conventional flashlight provides a light with a very small area of illumination coverage.

Additionally, since the emitted light is very directional the flashlight must be continuously moved to aim the flashlight to point in other directions to update the desired illumination area.

Furthermore, the conventional flashlight lacks versatility and cannot be used effectively as a worklight where a large area of light is required.

Therefore, there is need for an efficient portable worklight that emits a linear light to effectively illuminate a wide area.

### SUMMARY OF THE INVENTION

To achieve these and other advantages and in order to overcome the disadvantages of the conventional method in accordance with the purpose of the invention as embodied and broadly described herein, the present invention provides a portable worklight device that utilizes a point light emitted by a light emitting diode of a flashlight battery housing and coverts the light to produce a linear light source.

The portable linear worklight of the present invention comprises a worklight body with a lens opening. A transparent or translucent lens covers the lens opening. An inner sleeve inside the worklight body holds the lens inside the lens opening. A transparent light pipe is positioned between an upper reflector and a lower reflector inside the inner sleeve.

The lower reflector holds the light pipe and supports the upper reflector. The lower reflector covers the bottom surface and the side surfaces of the light pipe and reflects light back into the light pipe.

When the portable linear worklight is connected to a battery housing of a flashlight, a light emitting diode in the battery housing emits light into a light receiving end of the light pipe. The received light travels trough the light pipe and is emitted from a light emitting surface of the light pipe.

The upper reflector reflects some of the light emitted from the light emitting surfaces and directs the light toward the lens in the lens opening and the light exits the worklight body. As a result, the portable linear worklight of the present invention converts the point light emitted by the light emitting diode and coverts the light to provide a linear light source.

Utilizing the upper and lower reflectors the emitted light intensity and emitted light uniformity are optimized.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is an isometric drawing illustrating a portable linear worklight according to an embodiment of the present invention;

FIG. 2 is a top view drawing illustrating a portable linear worklight according to an embodiment of the present invention;

FIG. 3 is a side view drawing illustrating a portable linear worklight according to an embodiment of the present invention;

FIG. 4 is a side view drawing illustrating a portable linear worklight according to an embodiment of the present invention;

FIG. 5 is a front view drawing illustrating a portable linear worklight according to an embodiment of the present invention;

FIG. 6 is a rear view drawing illustrating a portable linear worklight according to an embodiment of the present invention;

FIG. 7 is a drawing illustrating internal components of a portable linear worklight according to an embodiment of the present invention;

FIG. 8 is an end view drawing illustrating an upper reflector according to an embodiment of the present invention;

FIG. 9 is a cross-sectional view drawing illustrating an upper reflector according to an embodiment of the present invention;

FIG. 10 is a drawing illustrating a lower reflector according to an embodiment of the present invention;

FIG. 11 is a drawing illustrating a light pipe according to an embodiment of the present invention; and

FIG. 12 is an end view drawing illustrating a worklight body and inner sleeve with sleeve arms according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

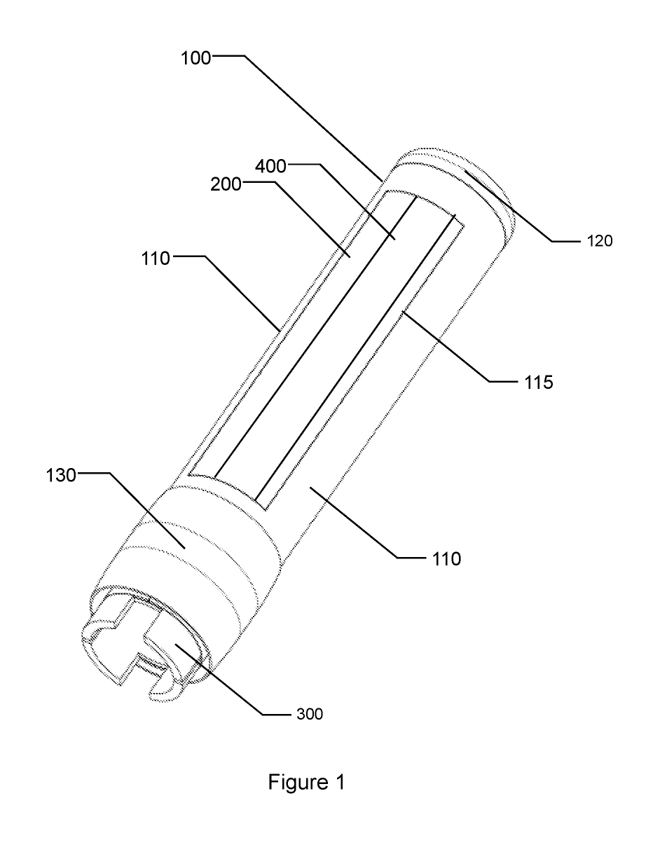

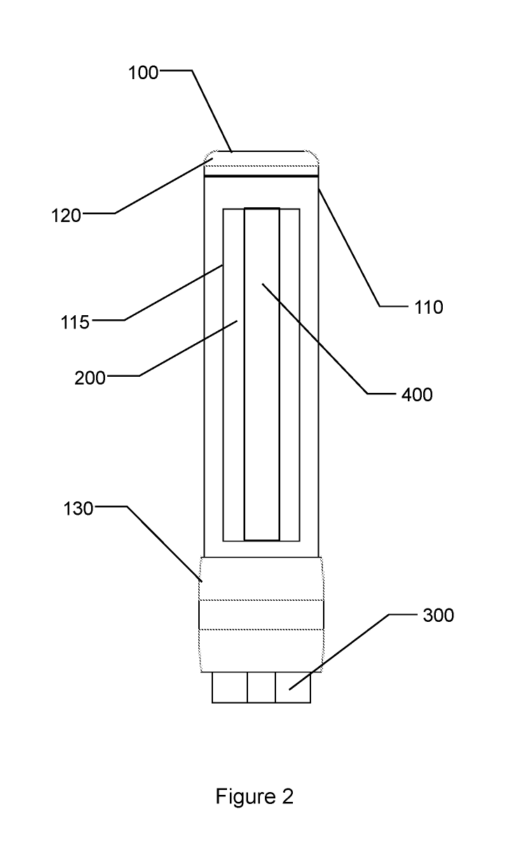

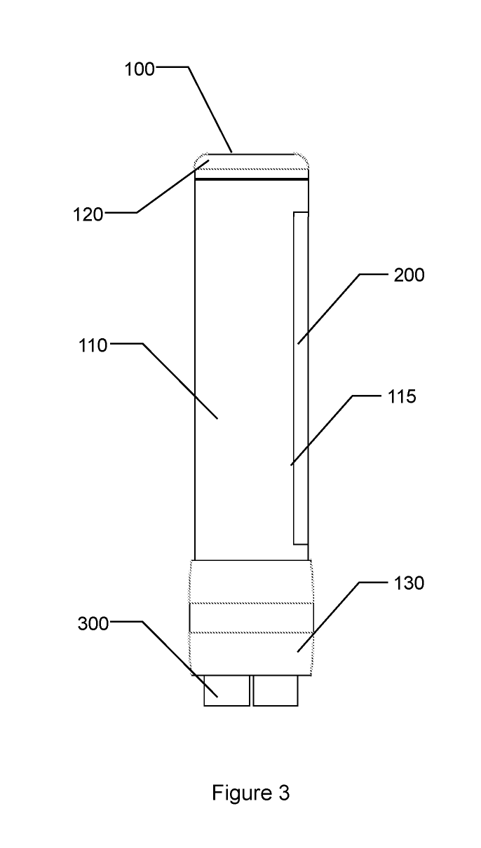

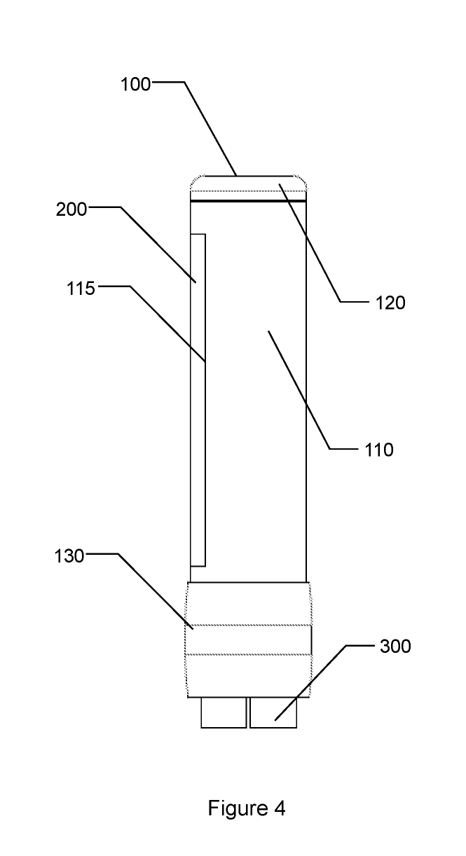

Refer to FIGS. 1-4, which are drawings illustrating a portable linear worklight according to an embodiment of the present invention.

The portable linear worklight 100 comprises a worklight body 110 that provides the main barrel body and holds the internal components of the portable linear worklight 100.

The worklight body 110 comprises a front body 130, a rear body 120, and a lens opening 115.

The portable linear worklight 100 further comprises a lens 200 and a light pipe 400.

The light pipe 400 converts spot light emitted by a light emitting diode in an attached light base into linear light.

The lens 200 provides a protective cover over the light pipe 400 to prevent physical contact with the light pipe 400. In an embodiment of the present invention the lens 200 comprises a transparent material to maximize the intensity of emitted light. In another embodiment the lens 200 comprises a translucent material to diffuse the emitted light.

The lens opening 115 in the worklight body 110 is provided for allowing light emitted by the light pipe 400 to pass through the lens 200 and exit the worklight body 110 to produce a linear light source.

A plurality of sleeve arms 300 of an inner sleeve extend from the front body 130 of the worklight body 110. The inner sleeve disposed inside the worklight body 110 hold edges of the lens 200 to keep the lens 200 inside the worklight body 110 while the lens 200 covers the lens opening 115.

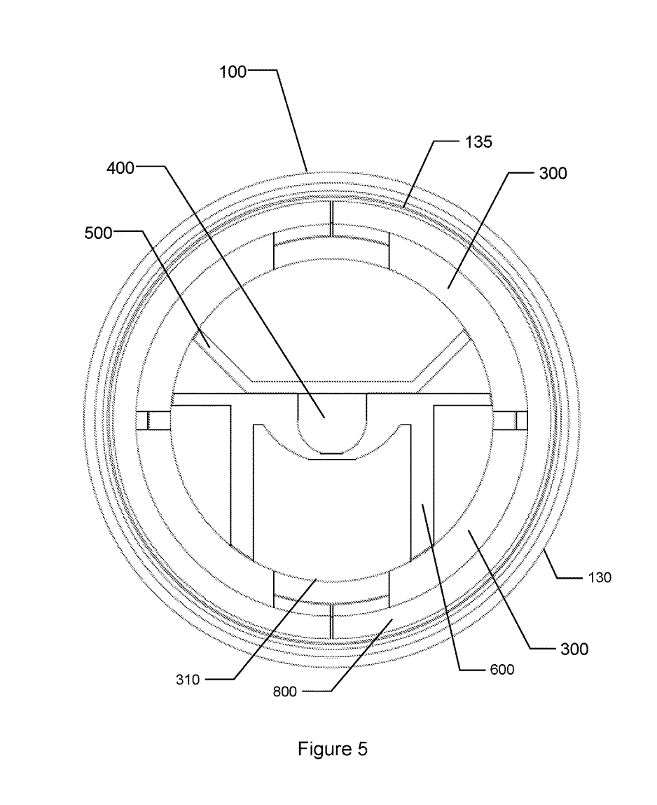

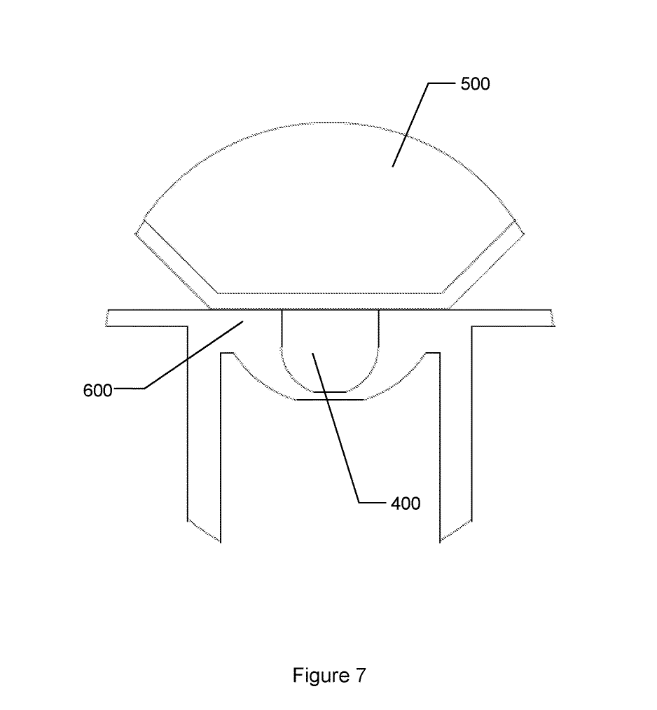

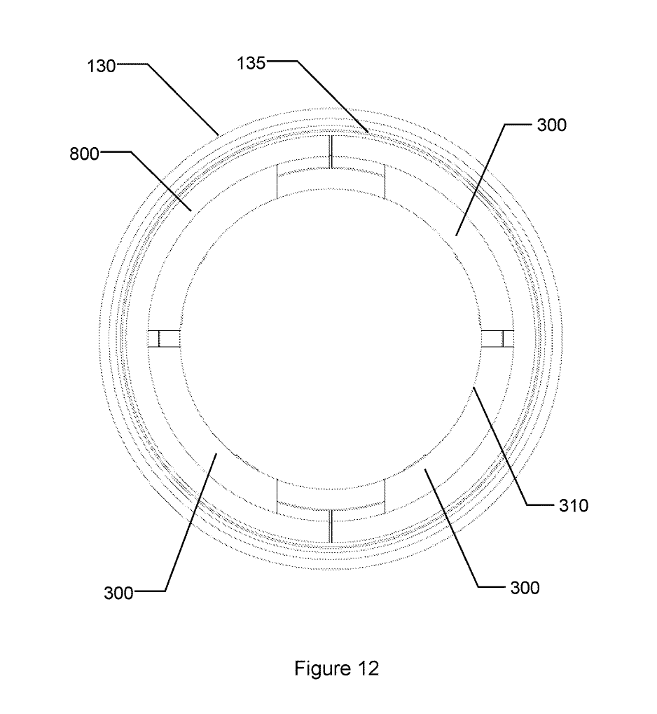

Refer to FIG. 5, which is a front view drawing illustrating a portable linear worklight according to an embodiment of the present invention, to FIG. 7, which is a drawing illustrating internal components of a portable linear worklight according to an embodiment of the present invention, and to FIG. 12, which is an end view drawing illustrating a worklight body and inner sleeve with sleeve arms according to an embodiment of the present invention.

The portable linear worklight 100 further comprises an upper reflector 500, a lower reflector 600, and the inner sleeve 800 disposed inside the worklight body.

The outer surface of the inner sleeve 800 is positioned against the inner surface of the worklight body.

The upper reflector 500 is disposed on top of the lower reflector 600 and both the upper reflector 500 and the lower reflector are positioned against the sleeve inner surface 310.

The light pipe 400 is disposed in the lower reflector 600 and held by the upper reflector 500.

On the inside surface of the front body end 130 threads 135 are provided for screwing the portable linear worklight 100 onto a battery housing.

The inner sleeve 800 further comprises sleeves 300 that extend through the opening in the front body 130. When the portable linear worklight 100 is threaded onto a battery housing the sleeve arms 300 activate a light emitting diode inside the battery housing and the light emitting diode emits light into a light receiving end of the light pipe 400.

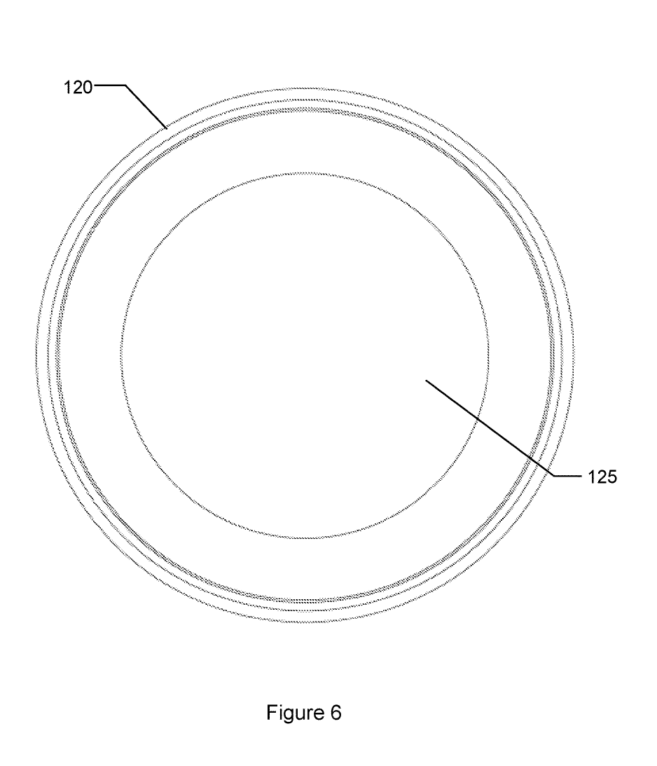

Refer to FIG. 6, which is a rear view drawing illustrating a portable linear worklight according to an embodiment of the present invention.

The rear body 120 further comprises a rear body end 125. The rear body end 125 provides an enclosure end to protect and seal the ends of the internal components of the portable linear worklight inside of the worklight body.

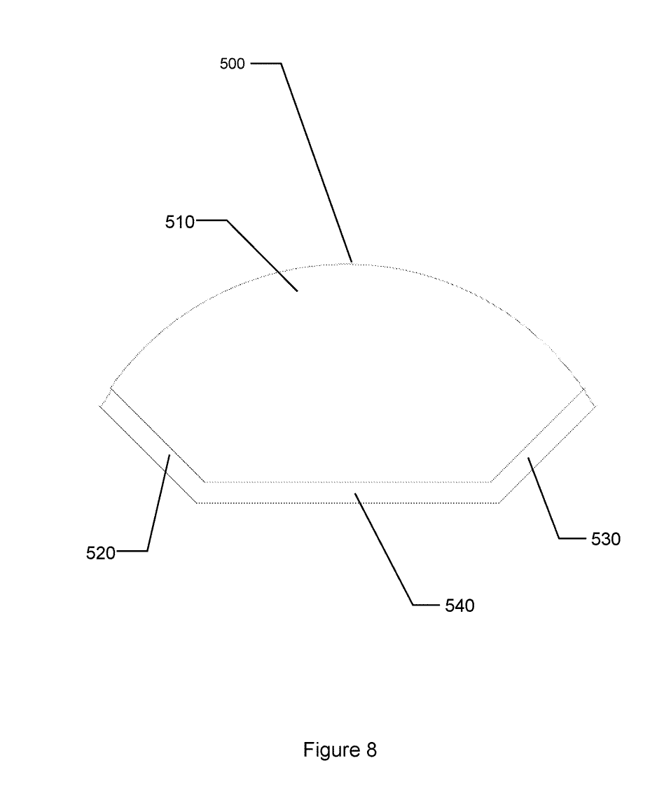

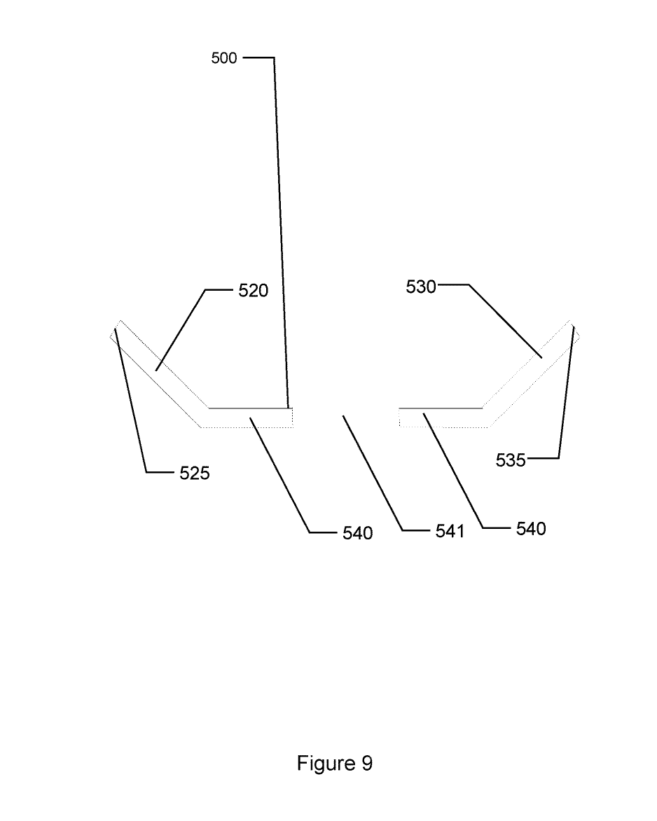

In an embodiment of the present invention the interior surface of the rear body end 125 comprises a reflective surface for reflecting light back into the light pipe or back into the worklight body to increase the intensity of emitted light. Refer to FIG. 8, which is an end view drawing illustrating an upper reflector according to an embodiment of the present invention, and to FIG. 9, which is a cross-sectional view drawing illustrating an upper reflector according to an embodiment of the present invention, and continue to refer to FIG. 5.

The upper reflector 500 comprises an upper front reflector 510, a left reflector 520, a left upper tip 525, a right reflector 530, a right upper tip 535, an upper reflector base 540, and a light pipe opening 541.

The left reflector 520 is disposed on a left side of the upper reflector base 540. The left upper tip 525 is disposed on the end of the left reflector 520. The right reflector 530 is disposed on a right side of the upper reflector base 540. The right upper tip 535 is disposed on the end of right reflector 530.

The upper front reflector 510 is disposed on a front end of the upper reflector base 540 between the left reflector 520 and the right reflector 530.

The left upper tip 525 and the right upper tip 535 contact the sleeve interior surface of the inner sleeve.

The light pipe opening 541 is disposed in the upper reflector base 540 to allow light emitted by the light pipe to pass through the upper reflector base 540. Edges of the upper reflector base 540 around the light pipe opening 541 hold the light pipe inside the lower reflector.

The left reflector 520, the right reflector 530, and the upper reflector base 540 reflect some of the light emitted by the light pipe through the light pipe opening 541 toward the lens. As a result, the upper reflector 500 conserves light to increase the intensity of emitted light.

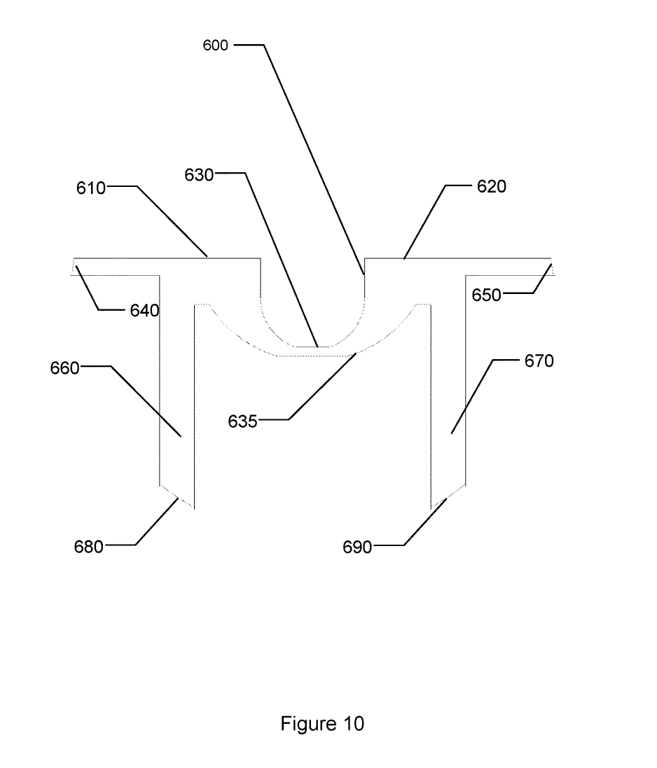

Refer to FIG. 10, which is a drawing illustrating a lower reflector according to an embodiment of the present invention and continue to refer to FIG. 5.

The lower reflector 600 comprises a left lower shelf 610, a right lower shelf 620, a light pipe holder reflector 630, a lower bottom 635, a left shelf tip 640, a right shelf tip 650, a left leg 660, a right leg 670, a left leg tip 680, and a right leg tip 690.

The light pipe holder reflector 630 is disposed between the left lower shelf 610 and the right lower shelf 620. The light pipe holder reflector 630 holds the light pipe and reflects light back into the light pipe bottom surface and side surfaces to conserve light and prevent light from being emitted anywhere else but through the light emitting surface of the light pipe.

The left shelf tip 640 is disposed on an end of the left lower shelf 610. The right shelf tip 650 is disposed on an end of the right lower shelf 620.

The left leg 660 is disposed under the left lower shelf 610 and the right leg 670 is disposed under the right lower shelf 620. The left leg tip 680 is disposed on an end of the left leg 660 and the right leg tip 690 is disposed on an end of the right leg 670.

The lower bottom 635 is disposed under the light pipe holder reflector 630 between the left leg 660 and the right leg 670.

The left shelf tip 640, the right shelf tip 650, the left leg tip 680, and the right leg tip 690 contact the sleeve interior surface of the inner sleeve.

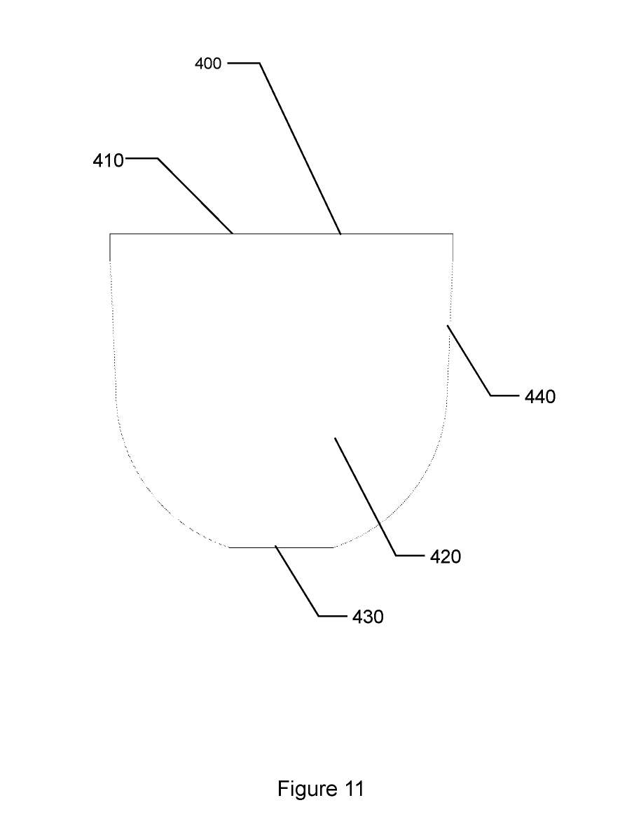

Refer to FIG. 11, which is a drawing illustrating a light pipe according to an embodiment of the present invention and continue to refer to FIG. 5.

The light pipe 400 comprises a light receiving surface 420, a light emitting surface 410, a light pipe bottom 430, and light pipe side surfaces 440.

The light pipe 400 further comprises an elongated transparent material.

When assembled the light pipe bottom 430 and the light pipe side surfaces 440 sit inside the light pipe holder reflector of the lower reflector. The light emitting surface 410 is aligned with the light pipe opening of the upper reflector. The upper reflector base holds the light pipe 400 inside the light pipe holder reflector.

In operation, light emitted by the light emitting diode of the battery housing enters the light receiving surface 420 and travels through the light pipe 400 and exits via the light emitting surface 410. Some light is reflected back into the light pipe 400 by the light pipe holder reflector of the lower reflector.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A portable linear worklight comprising:
a worklight body;
an inner sleeve disposed inside the worklight body;
a light pipe for converting point light into linear light;
a lens for allowing light emitted by the light pipe to exit the worklight body;
an upper reflector for reflecting light emitted by the light pipe toward the lens; and
a lower reflector for supporting the light pipe and the upper reflector.

2. The portable linear worklight of claim 1, the worklight body comprising:
a lens opening for allowing light to exit the worklight body via the lens;
a rear body
a rear body end disposed on the rear body;
a front body; and
threads disposed on the front body for attaching the portable linear worklight to a battery housing.

3. The portable linear worklight of claim 2, the lens comprising a transparent or translucent material, and edges of the lens are held inside the worklight body by the inner sleeve while the lens spans the lens opening.

4. The portable linear worklight of claim 1, the inner sleeve comprising:
a plurality of sleeve arms, the sleeve arms extending from the inner sleeve and out of the worklight body; and
a sleeve interior surface, the upper reflector and the lower reflector contacting the sleeve interior surface to hold the upper reflector and the lower reflector inside the inner sleeve.

5. The portable linear worklight of claim 1, the light pipe comprising:
a light receiving end for receiving light emitted by a light emitting diode;
a light emitting surface for emitting light;
a light pipe bottom for being held in the lower reflector; and
a pair of light pipe sides, the light pipe bottom disposed between the pair of light pipe sides and opposite the light emitting surface.

6. The portable linear worklight of claim 1, the upper reflector comprising:
an upper reflector base;
a left reflector disposed on a left side of the upper reflector base;
a left upper tip disposed on the left reflector;
a right reflector disposed on a right side of the upper reflector base;
a right upper tip disposed on the right reflector;
an upper front reflector disposed on a front end of the upper reflector base between the left reflector and the right reflector; and
a light pipe opening, the light pipe opening in the upper reflector base to allow light emitted by the light pipe to pass through the upper reflector base.

7. The portable linear worklight of claim 1, the lower reflector comprising:
a left lower shelf;
a right lower shelf;
a light pipe holder reflector disposed between the left lower shelf and the right lower shelf, the light pipe holder reflector holding the light pipe;
a left shelf tip disposed on the left lower shelf;
a right shelf tip disposed on the right lower shelf;
a left leg disposed under the left lower shelf;
a right leg disposed under the right lower shelf;
a left leg tip disposed on the left leg;
a right leg tip disposed on the right leg; and
a lower bottom disposed under the light pipe holder reflector and between the left leg and the right leg.

8. The portable linear worklight of claim 1, the upper reflector and the lower reflector contacting an interior surface of the worklight body.

9. The portable linear worklight of claim 1, the portable linear worklight emitting linear light when an light emitting diode in an attached battery housing emits point light.

10. A portable linear worklight comprising:
a worklight body for providing a main housing for the portable linear worklight, the worklight body comprising:
a lens opening formed in a side surface of the worklight body;
a rear body;
a front body on an opposite end of the worklight body from the rear body; and
threads formed on the front body for connecting the worklight body to a battery holder;
an inner sleeve disposed inside the worklight body, the inner sleeve comprising;
at least one sleeve arm extending through the front body;
a light pipe comprising:
a light receiving end for receiving light emitted by a light emitting diode; and
a light emitting surface for emitting light received by the light receiving end;
a lens spanning the lens opening;
an upper reflector for reflecting light emitted by the light emitting surface of the light pipe toward the lens opening of the worklight body; and
a lower reflector for holding the light pipe, the lower reflector contacting the upper reflector,
wherein the light pipe is positioned between the upper reflector and the lower reflector; and
wherein the light pipe, the upper reflector, and the lower reflector are positioned inside the inner sleeve.

11. The portable linear worklight of claim 10, wherein the threads are disposed on an interior surface of the front body.

12. The portable linear worklight of claim 10, wherein the at least one sleeve arm activates a light emitting diode in the battery holder to emit light when the worklight body is connected to the battery holder.

13. The portable linear worklight of claim 10, the inner sleeve further comprising:
a sleeve interior surface, the sleeve interior surface contacting the upper reflector and the lower reflector.

14. The portable linear worklight of claim 10, the light pipe comprising an elongated transparent material.

15. The portable linear worklight of claim 10, the light pipe further comprising:
a light pipe bottom disposed on an opposite surface of the light pipe from the light emitting surface; and
a plurality of light pipe sides disposed between the light emitting surface and the light pipe bottom.

16. The portable linear worklight of claim 10, the lens comprising a transparent or translucent material.

17. The portable linear worklight of claim 10, wherein edges of the lens are held inside the worklight body by the inner sleeve.

18. The portable linear worklight of claim 10, the upper reflector comprising:
an upper reflector base comprising a base front, a base rear, a left side, and a right side;
a left reflector disposed on the left side extending from the base front to the base rear of the upper reflector base;
a left upper tip disposed on the left reflector;
a right reflector disposed on the right side extending from the base front to the base rear of the upper reflector base;
a right upper tip disposed on the right reflector;
an upper front reflector disposed on the base front of the upper reflector base spanning the left reflector and the right reflector; and
a light pipe opening in the upper reflector base for allowing light emitted by the light emitting surface of the light pipe to pass through the upper reflector base.

19. The portable linear worklight of claim 10, the lower reflector comprising:
a left lower shelf;
a right lower shelf, the left lower shelf and the right lower shelf contacting the upper reflector base of the upper reflector;
a light pipe holder reflector disposed between the left lower shelf and the right lower shelf, the light pipe holder reflector for holding the light pipe and for reflecting light back into the light pipe bottom and the plurality of light pipe sides;
a left shelf tip disposed on the left lower shelf;
a right shelf tip disposed on the right lower shelf;
a left leg disposed under the left lower shelf;
a right leg disposed under the right lower shelf;
a left leg tip disposed on the left leg;
a right leg tip disposed on the right leg; and
a lower bottom disposed under the light pipe holder reflector and between the left leg and the right leg.

20. A portable linear worklight comprising:
a worklight body for providing a main housing for the portable linear worklight, the worklight body comprising:
a lens opening formed in a side surface of the worklight body;
a rear body;
a rear body end on the rear body;
a front body on an opposite end of the worklight body from the rear body; and
threads formed on an interior surface of the front body for connecting the worklight body to a battery holder;
an inner sleeve disposed inside the worklight body, the inner sleeve comprising;
at least one sleeve arm extending through the front body, the at least one sleeve arm activating a light emitting diode in the battery holder to emit light when the worklight body is connected to the battery holder; and
a sleeve interior surface;
a light pipe comprising an elongated transparent material, the light pipe comprising:
a light receiving end for receiving light emitted by the light emitting diode;
a light emitting surface for emitting light received by the light receiving end to produce a linear light source;
a light pipe bottom disposed on an opposite surface of the light pipe from the light emitting surface; and
a plurality of light pipe sides disposed between the light emitting surface and the light pipe bottom;
a lens comprising a transparent or translucent material spanning the lens opening, and edges of the lens are held inside the worklight body by the inner sleeve;
an upper reflector for reflecting light emitted by the light emitting surface of the light pipe toward the lens opening of the worklight body, the upper reflector comprising:
an upper reflector base comprising a base front, a base rear, a left side, and a right side;
a left reflector disposed on the left side extending from the base front to the base rear of the upper reflector base;
a left upper tip disposed on the left reflector;
a right reflector disposed on the right side extending from the base front to the base rear of the upper reflector base;
a right upper tip disposed on the right reflector;
an upper front reflector disposed on the base front of the upper reflector base spanning the left reflector and the right reflector; and
a light pipe opening in the upper reflector base for allowing light emitted by the light emitting surface of the light pipe to pass through the upper reflector base; and
a lower reflector disposed inside the inner sleeve, the lower reflector comprising:
a left lower shelf;
a right lower shelf, the left lower shelf and the right lower shelf contacting the upper reflector base of the upper reflector;
a light pipe holder reflector disposed between the left lower shelf and the right lower shelf, the light pipe holder reflector for holding the light pipe and for reflecting light back into the light pipe bottom and the plurality of light pipe sides;
a left shelf tip disposed on the left lower shelf;
a right shelf tip disposed on the right lower shelf;
a left leg disposed under the left lower shelf;
a right leg disposed under the right lower shelf;
a left leg tip disposed on the left leg;
a right leg tip disposed on the right leg; and
a lower bottom disposed under the light pipe holder reflector and between the left leg and the right leg.
